(19) United States
(12) Patent Application Publication
(10) Pub. No.: US 2021/0094668 A1
(43) Pub. Date: Apr. 1, 2021

(54) STRATOSPHERIC BALLOON LAUNCH MODULATION SYSTEM

(71) Applicant: LOON LLC, Mountain View, CA (US)

(72) Inventor: Mike Kennan, Oakland, CA (US)

(21) Appl. No.: 16/589,305

(22) Filed: Oct. 1, 2019

(51) Int. Cl. B64B 1/62; B64B 1/40; B64F 1/04; G01L 17/00

(52) U.S. Cl. CPC B64B 1/62; G01L 17/005; B64F 1/04; B64B 1/40

(57) ABSTRACT

Launching lighter-than-air craft, such as stratospheric balloons, includes filling an envelope with lift gas. Depending on the size and configuration of the envelope, inflation can place excess tension on one or more points along the envelope. This tension can cause undue stress on the material, which can adversely impact the ability of the lighter-than-air craft remaining aloft for long periods of time. Aspects of the technology employ a load cell to measure tension as the envelope is filled with lift gas. Information from the load cell is used to modulate one or more elements of a launch rig to regulate the tension during fill. The load cell may be mounted in proximity to one or more attachment points between the envelope and the launch rig. The load cell readings are cross-referenced with the amount of lift gas in the envelope, and the modulation is adjusted according to this information.

### BACKGROUND

Communications connectivity via the Internet, cellular data networks and other systems is available in many parts of the world. However, there are many locations where such connectivity is unavailable, unreliable or subject to outages from natural disasters and other problems. Some systems provide network access to remote locations or to locations with limited networking infrastructure via high altitude platforms operating in the stratosphere, for instance using lighter-than-air platforms that take advantage of wind currents to stay aloft for weeks, months or longer.

Launch of such platforms involves inflating an envelope or other enclosure with lift gas. However, if the inflation process is not carefully controlled, excess tension may be applied to one or more points along the envelope. This tension can cause undue stress on the material, which can adversely impact the ability of the lighter-than-air platform remaining aloft for long periods of time.

### BRIEF SUMMARY

Aspects of the present disclosure are advantageous for high altitude lighter-than-air craft. A launch system and process are employed that measure tension on the envelope during inflation, and use this information to modulate positioning of the envelope in a launch rig to ensure the tensioning is within predefined limits. As a result, a high altitude platform can be filled with lift gas without placing undue stress on the inflatable housing, and then launched for extended operation in the upper atmosphere.

According to one aspect, a system for inflating a balloon envelope of a balloon configured to operation in the stratosphere is provided. The system comprises a support structure and a fill device. The support structure includes two side support members and a lateral support member connecting the two side support members. The support structure defines an interior space for filling the balloon envelope. The fill device is configured to introduce a lift gas into the balloon envelope. The system also comprises one or more attachment devices releasably coupled to an exterior surface of the balloon envelope along one or more points therealong. The system further comprises at least one tension measurement device operatively coupled to the one or more attachment devices. The tension measurement device is configured to obtain tension information of the balloon envelope during introduction of the lift gas into the balloon envelope. A control module of the system is configured to receive the tension information from the at least one tension measurement device and receive fill information from the fill device regarding an amount of the lift gas introduced into the balloon envelope. The control module calculates a buoyancy of the balloon envelope based on the received fill information, and is configured to control modulation of the support structure relative to the balloon envelope based on the calculated buoyancy of the balloon envelope and the received tension information to keep tension below a threshold value.

In one example the least one tension measurement device is arranged to obtain tension information associated with a top plate disposed along an apex of the balloon envelope. In another example the at least one tension measurement device is arranged to obtain tension information associated with a base plate disposed along a base portion of the balloon envelope.

The control module may be configured to control modulation of the support structure relative to a top plate disposed along an apex of the balloon envelope. Alternatively or additionally, the control module is configured to control modulation of the support structure relative to a releasable restraint coupled to a portion of the balloon envelope.

In another example, the control module is configured to vary modulation of the support structure relative to the balloon envelope depending upon a location of the least one tension measurement device. And in yet another example, the control module is further configured to control modulation of the support structure relative to the balloon envelope based on information received from one or more of an environmental sensor, a position sensor, or a location sensor. In one implementation, the control module may control modulation of the support structure by adjusting a height of a moveable beam.

In a further example, the system also includes a platform or moveable perch. The platform or moveable perch is arranged to support the balloon during fill.

In another example, when a threshold is reached indicating that the balloon envelope has enough lift gas to support itself, then the control module enables the balloon envelope to free modulate itself.

In a further example, the at least one tension measurement device is a load cell. Here, the at least one tension measurement device may also include an encoder.

In another aspect, the system may also include the balloon.

According to yet another aspect, a method of filling a balloon for launch is provided. The balloon includes a balloon envelope and payload. The method includes receiving during introduction of lift gas into the balloon envelope, by one or more processors of a control module, tension information from at least one tension measurement device operatively coupled to the balloon envelope. The method also includes receiving, by the one or more processors, fill information from a fill device regarding an amount of the lift gas introduced into the balloon envelope. A buoyancy of the balloon envelope is calculated based on the received fill information. The method further includes the one or more processors controlling modulation of a support structure relative to the balloon envelope based on the calculated buoyancy of the balloon envelope and the received tension information to keep tension below a threshold value.

In one example, controlling the modulation of the support structure includes modulating the support structure relative to a top plate of the balloon disposed along an apex of the balloon envelope.

In another example, controlling the modulation of the support structure includes modulating the support structure relative to a releasable restraint coupled to a portion of the balloon envelope.

In a further example, controlling the modulation of the support structure includes varying modulation of the support structure relative to the balloon envelope depending upon a location of the least one tension measurement device.

Controlling the modulation of the support structure may be further based on information received from one or more of an environmental sensor, a position sensor, or a location sensor.

In another example, controlling the modulation of the support structure includes adjusting a height of a moveable beam of the support structure.

And according to yet another aspect, a non-transitory computer-readable recording medium is provided having instructions stored thereon. The instructions, when executed by one or more processors of a control module, cause the control module to implement a method of filling a balloon for launch. The balloon includes a balloon envelope and payload. Here, the method comprises receiving, during introduction of lift gas into the balloon envelope, tension information from at least one tension measurement device operatively coupled to the balloon envelope; receiving fill information from a fill device regarding an amount of the lift gas introduced into the balloon envelope; calculating a buoyancy of the balloon envelope based on the received fill information; and controlling modulation of a support structure relative to the balloon envelope based on the calculated buoyancy of the balloon envelope and the received tension information to keep tension below a threshold value.

### BRIEF DESCRIPTION OF THE DRAWINGS

FIG. 1 is a functional diagram of a balloon system in accordance with aspects of the disclosure.

FIG. 2A is an example of a balloon in accordance with aspects of the disclosure.

FIG. 2B is an example of a balloon payload in accordance with aspects of the disclosure.

FIG. 3 is an example perspective view of a launch support structure in accordance with aspects of the disclosure.

FIG. 4 is an example view of an interior space of the support structure in accordance with aspects of the disclosure.

FIG. 5 is an example of a portion of a portable launch rig including in accordance with aspects of the disclosure.

FIG. 6 is an example of a platform, perch, and a releasable restraint in accordance with aspects of the disclosure.

FIG. 7 is an example of a portion of a portable launch rig in accordance with aspects of the disclosure.

FIGS. 8A-B are an example cart assembly in accordance with aspects of the disclosure.

FIGS. 9A-B are example lift gas supply carts in accordance with aspects of the disclosure.

FIG. 10 is an example control system in accordance with aspects of the disclosure.

FIGS. 11A-B illustrate a modulation example in accordance with aspects of the disclosure.

FIGS. 12A-D illustrate stages of a launch process in accordance with aspects of the disclosure.

FIG. 13 illustrates an example of a balloon upon launch in accordance with aspects of the disclosure.

FIG. 14 is an example flow diagram in accordance with aspects of the disclosure.

### DETAILED DESCRIPTION

### Overview

The technology relates to launching high altitude lighter-than air platforms, such as balloons configured for operation in the stratosphere. As an example, a typical balloon may include a balloon envelope having a top plate and a base plate, a plurality of tendons between the top plate and the base plate, and a payload such as to provide telecommunications or other services. It can be challenging to inflate a large balloon as part of the launch process. Various equipment can be used to aid the process. For instance, specialized clamps may hold the envelope during inflation. Wind shields and launch towers can also be used to protect the envelope and payload. In some configurations, a specialized portable launch rig (PLR) may be used.

In order to manage the tension of the envelope as it is filled with lift gas and to keep the tension within an acceptable limit, aspects of the technology employ a tension measurement device such as a load cell. Information from the load cell is used to modulate one or more elements of the PLR to regulate the tension during fill. The load cell may be mounted in proximity to one or more attachment points between the envelope and the PLR. The load cell readings are cross-referenced with the amount of lift gas in the envelope, and the modulation is adjusted according to this information.

As an example, a PLR may include a support structure surrounding an interior space configured for inflating and launching of balloons. The support structure may include rectangular supports at opposite sides of the support structure. Each rectangular support may include side supports and top and bottom beams. A lateral support beam may connect the rectangular support structures to one another at the side supports on a back side of the support structure. In one PLR configuration, a fourth side of the support structure is framed by the two parallel side beams and is generally open in order to permit a balloon to be moved into and out of the support structure for inflating and launching.

The support structure may also include a one or more jib cranes for lifting and inflating of the balloon. In one example, the support structure may include first and second jib cranes mounted to a top surface of the lateral support beam. The jib cranes include cables that extend downward towards the interior space of the PLR. In this configuration, at the end of each jib crane cable is a connection for connecting to a beam or jib spreader. Here, each cable is controlled by a corresponding hoist which may operate to extend and retract the cables of the first and second jib crane in order to lower and raise the jib spreader. In order to keep the jib spreader parallel with respect to the ground, the hoists may operate in unison or independently using a single controller.

The jib cranes may each include a first arm portion and a second arm portion. The first arm portions may be connected to the lateral support beam and extend upwards from and generally perpendicularly to the lateral support beam. The second arm portions may be connected to the respective first arm portions and extend over the interior space. In order to increase the range of movement of the jib spreader, the jib cranes may also be moveable in multiple degrees of freedom. For instance, each of the first arms of the jib cranes may be extended or retracted towards and away from the lateral support beam using a hydraulics system. The second arms may also be pivoted and rotated relative to the first arms. In addition, as with the first arms, the second arms may also be extended and retracted.

The jib spreader may include a mount for connecting an assembly for lifting a balloon. The assembly may also be configured to provide lift gas into the balloon envelope through an opening in the top plate of the balloon. In that regard, electrical and lift gas lines may be connected to the assembly from the jib spreader.

In order to provide wind protection to the interior space, the support structure may include a three-sided door assembly. The door assembly may include retractable hangar doors each set within a corresponding rectangular hangar door frame. When fully extended, these hangar doors are configured to block the wind from the interior space from the corresponding side of the support structure, while leaving a fourth side of the PLR open. When fully retracted, the doors may be rolled up completely or almost completely inside of three respective door housings arranged adjacent to the parallel top beams and lateral support beam. These rolling doors allow the PLR's support structure to withstand higher wind conditions without imposing higher wind loads on the support structure.

In order to lift, fill and launch the balloon, a platform may be arranged within the interior space. The platform may include lateral support bars which are each connected by cables to a corresponding one of the parallel top beams of the support structure. Each cable may be controlled by a corresponding hoist which may operate to extend and retract the corresponding cable in order to lower and raise lateral support bars towards and away from the parallel top beams thereby raising and lowering the platform. The hoists may operate in unison or independently and can be used to raise and lower the platform completely independent of the cables of the jib cranes and/or in unison with the hoists of the jib cranes.

The platform may be or may include a movable perch. The perch can pivot relative to the platform in order to lift the balloon during inflation as well as to move and lift the balloon during launch. In one configuration, a first end of the perch includes a releasable restraint for holding a portion of the balloon envelope to the perch during inflation and prior to launch. A second end of the perch may be configured for attachment with the payload of the balloon. For example, the second end may include a payload positioning assembly including two or more arm having end portions which are configured to clamp onto a portion of the balloon as well as a rest structure for holding the payload prior to launch. The payload positioning assembly may position or maintain the position of the payload until the releasable restraint has been released and the balloon envelope has reached a certain height or location relative to the payload where the payload is ready to be released. This reduces the likelihood that the payload will collide with the perch, platform, or ground after the payload is released during a launch.

In another example, the second end of the perch and/or the platform may include a connection member for connecting with a cart. On end of the cart may include a rest structure for holding the balloon's payload to the perch during inflation and prior to launch. The cart is may be used to move a packaged balloon stored in a box or other housing towards the support structure. A second end of the cart may include a payload positioning assembly including two or more arms having end portions which are configured to clamp onto a portion of the balloon.

As noted above, the PLR may be used not only to launch a balloon, but also the fill the balloon. In this regard, a lift gas supply may be provided. The lift gas supply may be integrated into the support structure in order to reduce the likelihood of kinking of the lift gas supply line when the support structure is moved. Alternatively, the lift gas supply may be an independent assembly, such as a lift gas supply cart. Again, in order to reduce kinking of the lift gas supply line when the support structure is moved, the lift gas supply cart may be configured to connect and move with the support structure.

The PLR is also configured to change the position and orientation of the support structure. Each of the bottom beams may include two or more wheels each having an independent hydraulics system to turn (angle) and rotate (drive) that wheel. The independent movement of each wheel allows the PLR to have many different types of movement such as 2-wheel and 4-wheel drive modes as well as various steering modes. By changing the orientation of the wheels, the PLR can always be maneuvered such that the fourth open side of the PLR can be rotated to downwind as wind conditions at a launch site change.

The various features of the PLR may be electrically connected to a control system. Various user inputs may be included within a cab. These user inputs may allow a human operator to communication with the control system in order to control the movement and position of the wheels, platform, perch, releasable restraint, payload positioning assembly, jib cranes, hangar doors, as well as various other features of the PLR.

The PLR may also include a data acquisition system. The data acquisition system may include various sensors arranged to detect the position and location of the wheels, platform, perch, releasable restraint, payload positioning assembly, jib cranes, hangar doors, as well as various other features of the PLR.

For instance, one or more load cells may be arranged to measure tension on the balloon envelope. The load cell tension information may be used by the control system to adjust one or both of the top and bottom beams, as well as other components of the PLR to ensure the tension remains within predetermined limits.

The PLR may also include a plurality of sensors configured to detect and provide information regarding current wind conditions outside of the PLR and also within the interior space. In addition, the control system may also communicate with the lift gas supply cart to control the inflation of a balloon envelope. These sensors may send information to the control system which processes the information and provides it for display, for example, on an electronic display within the cab to the operator.

In addition, the control system may be configured to send information to a remote computer via a communication link so that an operator outside of the cab may still be able to control the movement and position of the wheels platform, perch, releasable restraint, payload positioning assembly, jib cranes, top and bottom beams, hangar doors, as well as various other features of the PLR.

As noted above, the PLR may be used to lift, fill and launch a balloon. In order to do so, at least a portion of the balloon may be positioned within the interior space. A box or other housing containing that balloon may be placed on the perch within the interior space. The payload may be placed on the rest structure and the end portions of the arms may be clamped onto the base plate. In addition, a roller bar or other component of the releasable restraint may be temporarily clamped onto the balloon envelope and slid towards the first end of the perch and into the interior space.

In order to lift the balloon out of the box or other enclosure, the jib spreader may then be positioned over and lowered towards the box. The assembly for lifting the balloon may then be secured to the top plate. The hoists of the jib cranes may then retract the cables in order to raise the jib spreader and pull the balloon envelope out of the box.

Prior to or once the assembly is secured to the top plate the lift gas supply cart (if used) may be wheeled over to the support structure and connected to the lift gas line. Lift gas from the supply cart may then flow into the balloon envelope via the lift gas line and assembly, until the inflating is complete or the desired inflation pressure is reached within the balloon envelope.

During inflation, in order to manage the tension and keep it within an acceptable limit, the load cell(s) measure the tension. Information from the load cell(s) is used to modulate one or more elements of the PLR to regulate the tension during the fill process. In particular, the load cell(s) may be mounted in proximity to one or more attachment points between the envelope and the PLR assembly. The load cell information can include encoder positioning, which can be any system of measuring the location in space of the attachment points. By way of example, this could be encoders on a motor shaft, or encoders on the cables, or a positioning sensor on a hydraulic cylinder.

The control system can cross-reference the load cell information with the amount of lift gas in the envelope, in order to determine whether or how much to adjust the beam(s) or other components of the PLR. For instance, the platform and/or jib spreader may be raised or lowered in order to raise or lower the position of the top plate (and balloon envelope) and the angle of the perch changed in order to best position the balloon envelope for tensioning purposes and to account for current wind conditions at launch.

Once inflation is complete and the PLR is positioned for the current wind conditions, the balloon may be ready for launch. At this point, the top plate may be released from the assembly. At the same time or shortly thereafter, the assembly may be pulled away from the top plate. In one scenario for launch, the first end of the perch is swung upwards. Next, the balloon envelope is released from the releasable restraint by swinging the roller bar away from the releasable restraint. This causes the balloon envelope to begin to rise away from the first end of the perch. At an appropriate time thereafter, such as when the balloon envelope has passed over (or beyond) the payload, the end portions of arms may be released from the base plate. The arms may swing away from the base plate, allowing the balloon (including the payload) to float away and completing the launch.

### Example Balloon System

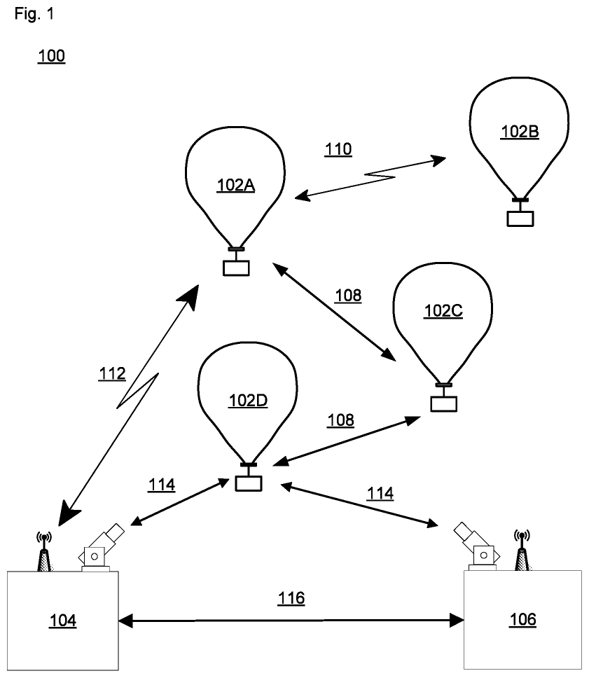

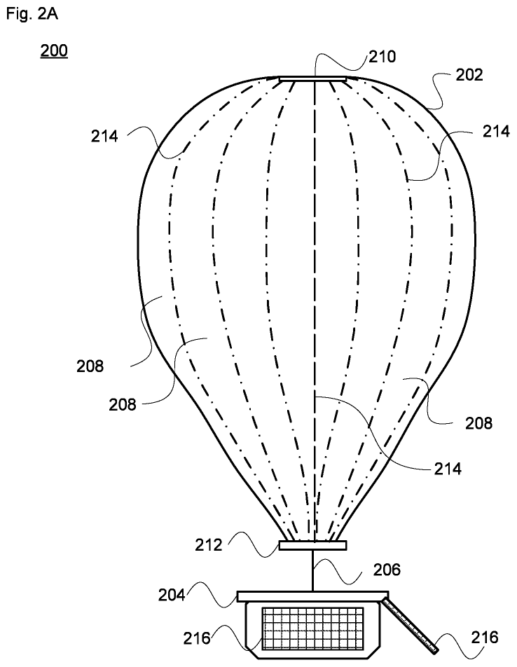

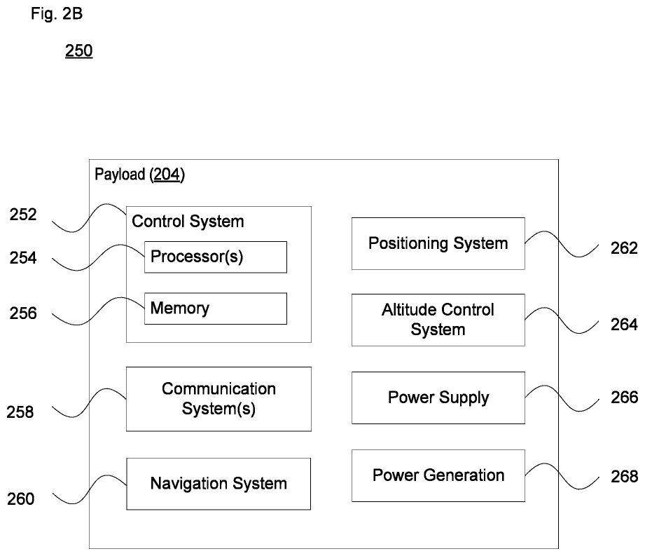

FIG. 1 depicts an example system 100 in which a fleet of balloon platforms or other lighter-than-air high altitude platforms (HAPs) above may be used. This example should not be considered as limiting the scope of the disclosure or usefulness of the features described herein. System 100 may be considered a balloon network. In this example, balloon network 100 includes a plurality of devices, such as balloons 102A-D as well as ground-based stations 104 and 106. Balloon network 100 may also include a plurality of additional devices, such as various computing devices (not shown) as discussed in more detail below or other systems that may participate in the network. One example of a balloon is discussed in greater detail below with reference to FIG. 2.

The devices in system 100 are configured to communicate with one another. As an example, the balloons may include communication links 108 and/or 110 in order to facilitate intra-balloon communications. By way of example, links 110 may employ radio frequency (RF) signals (e.g., millimeter wave transmissions) while links 108 employ free-space optical transmission. Alternatively, all links may be RF, optical, or a hybrid that employs both RF and optical transmission. In this way balloons 102A-D may collectively function as a mesh network for data communications. At least some of the balloons may be configured for communications with ground-based stations 104 and 106 via respective links 112 and 114, which may be RF and/or optical links. In addition, the ground-based stations 304 and 306 may communicate directly via link 116, which may be a wired or wireless link.

In one scenario, a given balloon 102 may be configured to transmit an optical signal via an optical link 308. Here, the given balloon 102 may use one or more high-power light-emitting diodes (LEDs) to transmit an optical signal. Alternatively, some or all of the balloons 102 may include laser systems for free-space optical communications over the optical links 108. Other types of free-space communication are possible. Further, in order to receive an optical signal from another balloon via an optical link 108, the balloon may include one or more optical receivers.

The balloons 102 may also utilize one or more of various RF air-interface protocols for communication with ground-based stations via respective communication links. For instance, some or all of balloons 102A-F may be configured to communicate with ground-based stations 104 and 106 via RF links 112 using various protocols described in IEEE 802.11 (including any of the IEEE 802.11 revisions), cellular protocols such as GSM, CDMA, UMTS, EV-DO, WiMAX, and/or LTE, 5G and/or one or more proprietary protocols developed for long distance communication, among other possibilities.

The balloons of FIG. 1 may be high-altitude balloons that are deployed in the stratosphere. As an example, in a high altitude balloon network, the balloons may generally be configured to operate at stratospheric altitudes, e.g., between 50,000 ft and 90,000 ft or more or less, in order to limit the balloons' exposure to high winds and interference with commercial airplane flights. In order for the balloons to provide desired coverage in the stratosphere, where winds may affect the locations of the various balloons in an asymmetrical or otherwise variable manner, the balloons may be configured to move latitudinally and/or longitudinally (transversely) by adjusting their respective altitudes, such that the wind carries the respective balloons to the respectively desired locations. Lateral propulsion may also be employed to affect a balloon's path of travel or to maintain time “on station” over a particular region.

### Example Balloon

FIG. 2A is an example balloon 200, which may represent any of the balloons 102 of balloon network 100. As shown, the balloon 200 includes an envelope 202 and a payload 204 connected to the envelope by a connection member 206 such as a down-connect or a tether. The balloon 200 may be configured, e.g., as a superpressure balloon and include one or more ballonets (not shown).

In a superpressure or other balloon arrangement, the envelope 202 may be formed from a plurality of gores 208 sealed to one another. An upper portion of the envelope 202 has an apex section configured for connection to an apex (or top) load ring or plate 210, and a lower portion having a base section configured for connection to a base load ring or plate 212 positioned at the bottom of the balloon envelope. Tendons (e.g., webbing or load tape) 214 are shown running longitudinally from the apex load ring 210 to the base load ring 212. The tendons are configured to provide strength to the gores and to help the envelope 202 withstand the load created by the pressurized gas within the envelope when the balloon is in use. There may be a 1:1 correspondence between the number of gores and the number of tendons. Alternatively, there may be more (or less) tendons than gores.

The envelope 202 may take various shapes and forms. For instance, the envelope 402 may be made of materials such as polyethylene, mylar, FEP, rubber, latex or other thin film materials or composite laminates of those materials with fiber reinforcements imbedded inside or outside. Other materials or combinations thereof or laminations may also be employed to deliver required strength, gas barrier, RF and thermal properties. Furthermore, the shape and size of the envelope 202 may vary depending upon the particular implementation. Additionally, the envelope 202 may be filled with different types of gases, such as air, helium and/or hydrogen. Other types of gases, and combinations thereof, are possible as well. Shapes may include typical balloon shapes like spheres and “pumpkins”, or aerodynamic shapes that are symmetric, provide shaped lift, or are changeable in shape. Lift may come from lift gasses (e.g., helium, hydrogen), electrostatic charging of conductive surfaces, aerodynamic lift (wing shapes), air moving devices (propellers, wings, electrostatic propulsion, etc.) or any hybrid combination of lifting techniques. One or more solar panels 216 may be arranged on or extending from the chassis of the payload 204.

As noted above, the payload 204 of balloon 200 may be affixed to the envelope 202 by a connection member 206, for instance a down-connect such as a cable or other rigid structure. FIG. 2A illustrates one example 250 of payload 204. As shown, the payload 204 may include a computer system such as control system 252, having one or more processors 254 and on-board data storage in memory 256. The payload 258 may also include various other types of equipment and systems to provide a number of different functions. For example, the payload 204 may include optical and/or RF communication systems 258, a navigation system 260, a positioning system 262, an altitude control system 264, a power supply 266 to supply power to various components of the payload 204, and a power generation system 268, which may include solar panels 216 as shown in FIG. 2.

### Example Launch System

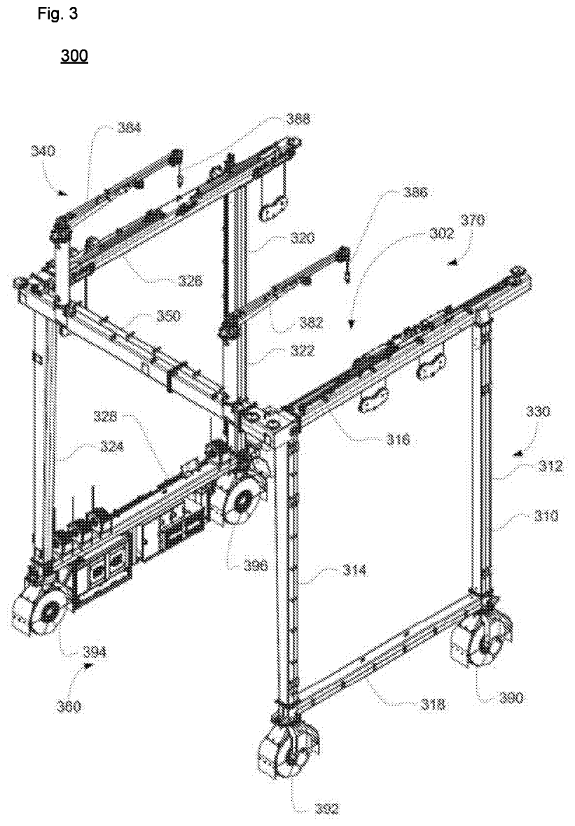

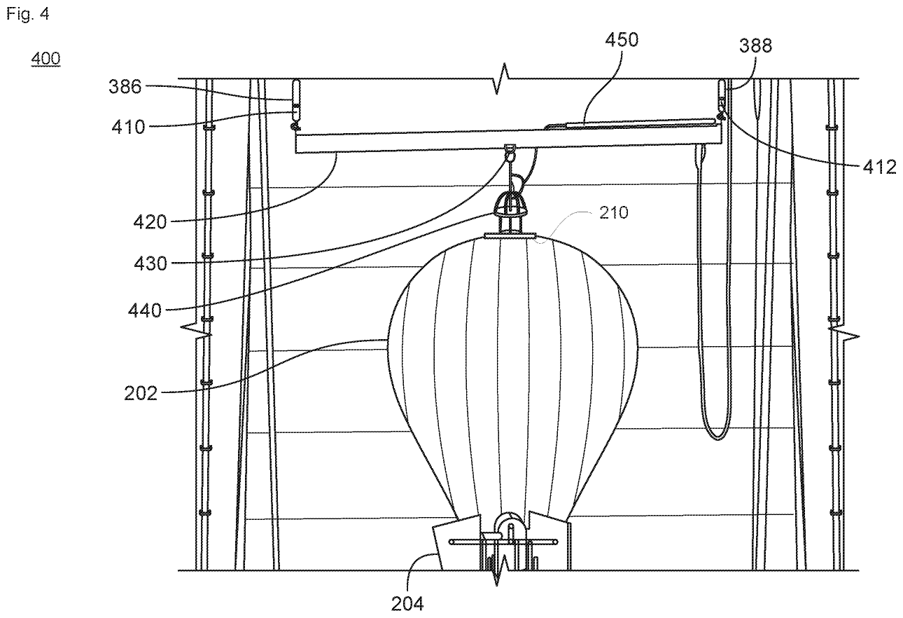

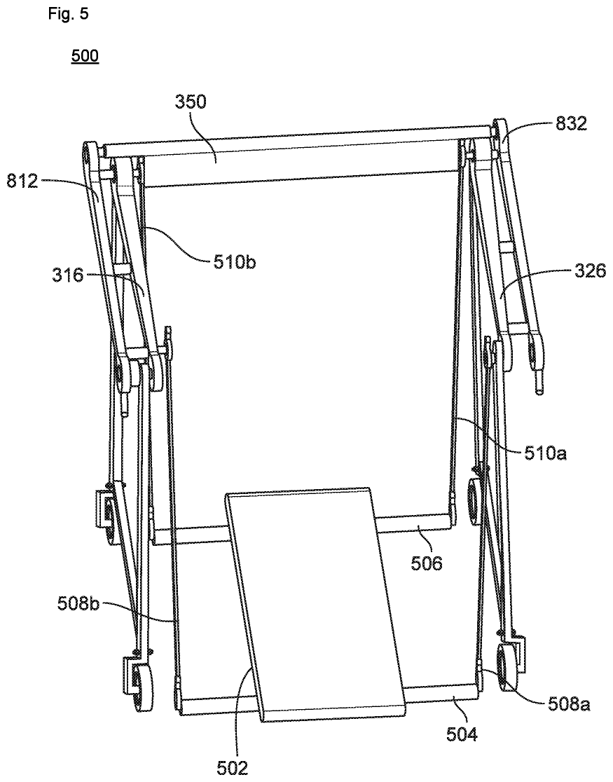

As shown in FIG. 3, an example PLR includes a support structure 300 surrounding an interior space 302 configured for inflating and launching of balloons. In one example, the support structure may be approximately 45 feet height, 35 feet wide and 40 feet in depth. The support structure 300 may include two rectangular supports 310, 320 on opposing left and right sides 330, 340, respectively, of the support structure. Each rectangular support includes two parallel side supports 312, 314, 322, 324, parallel top beams 316, 326, and parallel bottom beams 318, 328. In this regard, parallel side beams 312, 314, top beam 316, and bottom beam 318 form a first one of the rectangular supports. Similarly, parallel side beams 322, 324, top beam 326, and bottom beam 328 form a first one of the rectangular supports.

A lateral support beam 350 connects the rectangular support structures at the parallel side supports 314, 324 to one another on a third, back side 360 of the support structure. A fourth side 370 of the support structure 300 is framed by the two parallel side beams 312, 322 and is generally open in order to permit a balloon to be moved into and out of the support structure for inflating and launching.

The support structure may also include a one or more jib cranes for lifting and inflating of the balloons. In other words, the jib cranes operate to position the balloon and minimize movement prior to launch. In the example of FIG. 3, the support structure includes a first jib crane 382 and a second jib crane 384 mounted to a top surface of the lateral support beam 350. Each jib crane includes a cable 386, 388 that extends downward towards the interior space 302.

As shown in illustration 400 of FIG. 4, at the end of each jib crane cable are connections 410, 412 for connecting to a beam or jib spreader 420. Each cable may be controlled by a corresponding hoist which may operate to extend and retract the cables 386, 388 of the first and second jib crane in order to lower and raise the jib spreader 420. In order to keep the jib spreader parallel with respect to the ground, the hoists may operate in unison or independently using a single controller.

In order to increase the range of movement of the jib spreader 420, the jib cranes may also be moveable in multiple degrees of freedom. For instance, each of the arms of the jib cranes may be extended or retracted towards and away from the lateral support beam 350 (or rather, moved up and down), using a hydraulics system. In this regard the jib spreader 420 may move up and down and even above the parallel top beams 316, 326 of the support structure.

The jib spreader 420 includes a mount 430 for connecting an assembly 440 for lifting a balloon. The assembly 440 may also be configured to provide lift gas into the balloon envelope through an opening in the top plate of the balloon. In that regard, electrical and lift gas lines 450 may be connected to the assembly 440 from the jib spreader 410 as shown in FIG. 4. According to one example a load cell may be part of either the mount 430 or the assembly 440.

As noted above, in order to lift, fill and launch the balloons, a platform may be arranged within the interior space. FIG. 5 illustrates a platform assembly example 500. As shown, the platform assembly includes a platform 502 and two lateral support bars 504 and 506, which are each connected by two cables 508a-508b and 510a-510b, respectively, to a corresponding one of the parallel top beams 316, 326 of the support structure 300 of FIG. 3. Each cable 508 and 510 may be controlled by a corresponding hoist, which may be operated to extend and retract the corresponding cable in order to lower and raise lateral support bars 504, 506 towards and away from the parallel top beams 316, 326, thereby raising and lowering the platform. In order to keep the platform 5020 parallel with respect to the ground, the hoists may operate in unison or independently. The hoists used to raise and lower the platform may also be controlled with the single controller. In this regard, the cables can be used to raise and lower the platform completely independent of the cables of the jib cranes and/or in unison with the hoists of the jib cranes. In that regard, the movement of the jib cranes may be independent of or synchronized with the movement of the platform. Such operations can be employed in view of the data received from the load cell(s) to module the envelope tension during fill or launch.

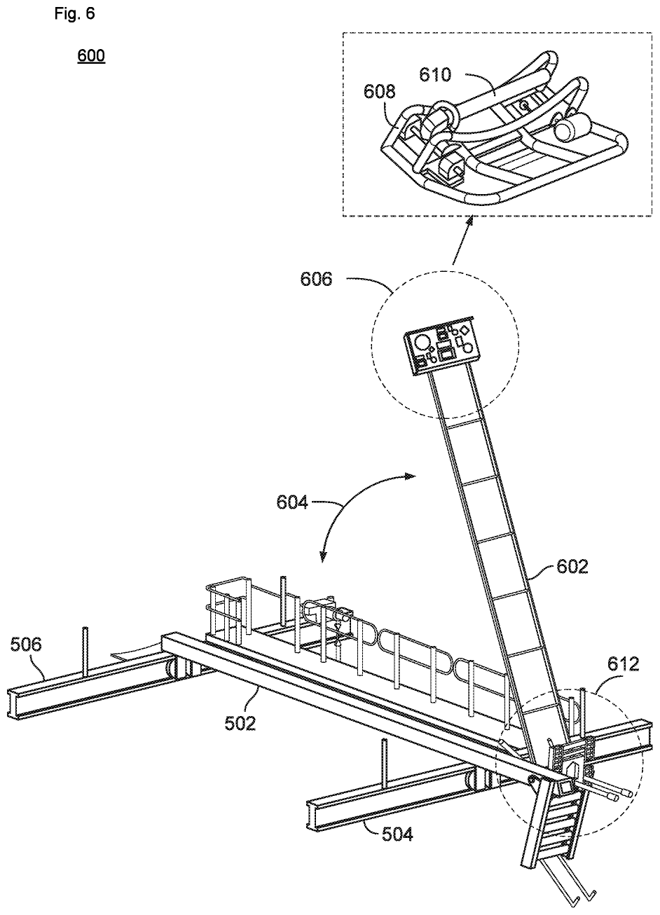

As shown in the example of FIG. 6, the platform 502 may be or may include a movable perch 602. The perch 602 can pivot relative to the platform 502 in the direction of arrows 604, using a hydraulics system (not shown), in order to lift the balloon during inflation as well as to move and lift the balloon during launch. A first end 606 of the perch includes a releasable restraint 608 for holding a portion of the balloon envelope to the perch during inflation and prior to launch. The releasable restraint includes a roller bar 610 which allows material of the balloon envelope to slide within the releasable restraint 608 without pulling on or damaging the material. In addition, the releasable restraint may 608 be configured to move along the perch 602 in order to assist an operator in positioning the balloon envelope on the perch.

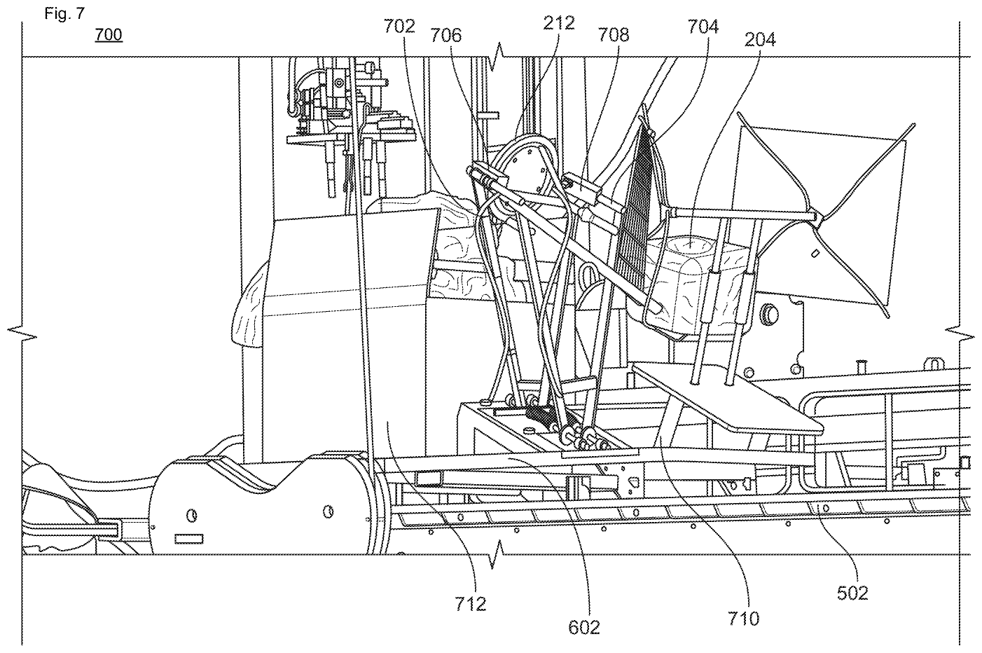

A second end 612 of the perch 602 may be configured for attachment with the payload of a balloon. For example, the second end may include or be attached to a payload positioning assembly, as shown in example 700 of FIG. 7, which includes two arms 702, 704 having end portions 706, 708 which are configured to clamp onto a portion of the balloon as well as a rest structure 710 for holding the payload prior to launch. The payload positioning assembly may position or maintain the position of the payload until the releasable restraint has been released and the balloon envelope has reached a certain height or location relative to the payload where the payload is ready to be released. This reduces the likelihood that the payload will collide with the perch, platform, or ground after the payload is released during a launch. As shown, a box or other housing 712 stores the uninflated balloon in the payload positioning assembly.

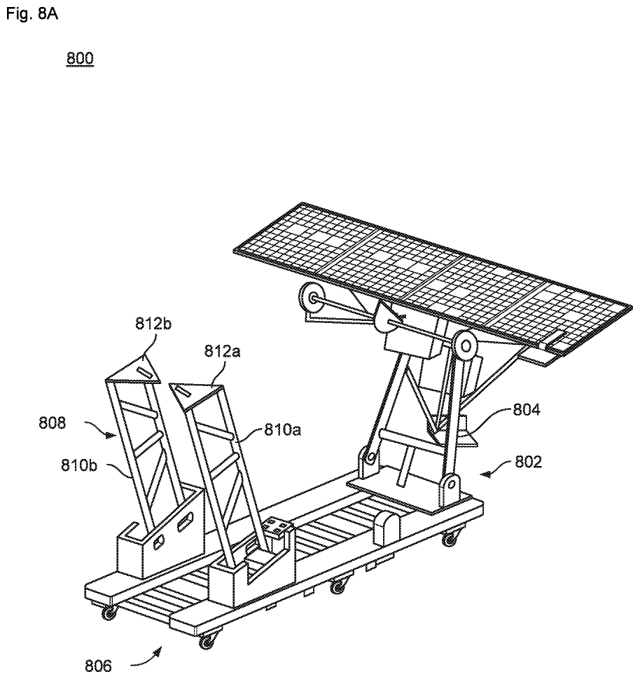

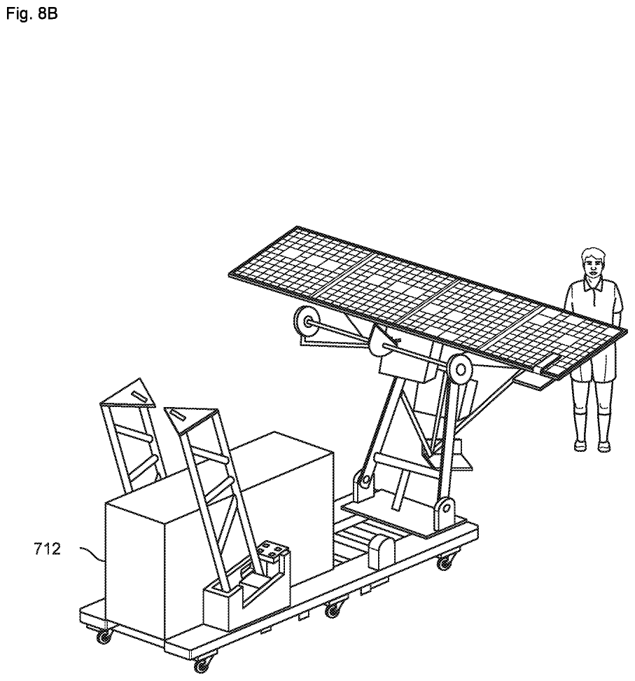

As shown in the example of FIG. 8A, one end 802 of a cart 800 may include a rest structure 804 for holding the balloon's payload to the perch during inflation and prior to launch. As shown in FIG. 8B, the cart 800 is sized to hold box 712 including a balloon. In this regard, the box 712 may be placed on the cart at one location (such as a warehouse, storage location, etc.), and the cart may be used to move the box towards the support structure. Once in position, the cart may be connected to the perch 602.

Returning to FIG. 8A, second end 806 of the cart 1410 may include a payload positioning assembly 808 including two arms 810a, 810b having end portions 812a, 812b which are configured to clamp onto a portion of the balloon. Payload positioning assembly 808 may position or maintain the position of the payload until the releasable restraint has been released and the balloon envelope has reached a certain height or location relative to the payload where the payload is ready to be released. This reduces the likelihood that the payload will collide with the perch, platform, or ground after the payload is released during a launch.

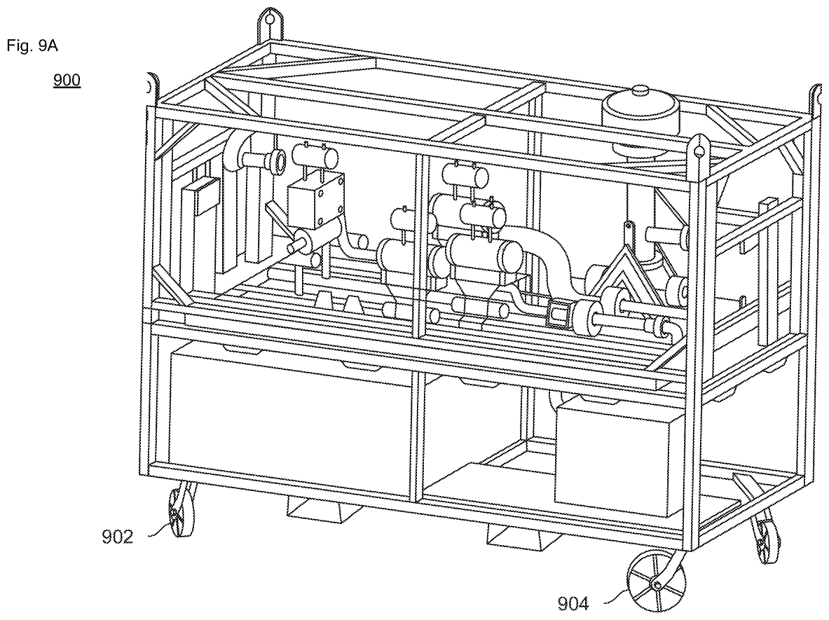

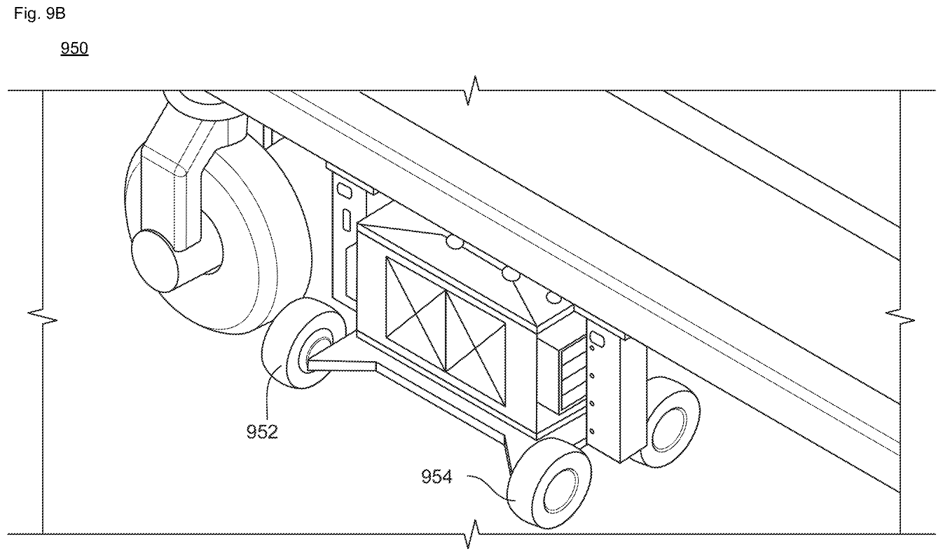

As noted above, the PLR may be used not only to launch a balloon, but also the fill the balloon. In this regard, a lift gas supply may be provided. The lift gas supply may be integrated into the support structure 300, in order to reduce the likelihood of kinking of the lift gas supply line when the support structure is moved. Alternatively, the lift gas supply may be an independent assembly, such as one of the lift gas supply carts 900 or 950 as shown in FIGS. 9A and 9B, respectively. Again, in order to reduce kinking of the lift gas supply line when the support structure is moved, the lift gas supply cart may be configured to connect and move with the support structure. When connected, the lift gas supply cart may include a gas supply that can connect with the lift gas line in order to fill a balloon envelope with lift gas. Because the supply carts 900 and 950 include wheels 902, 904 or 952, 954, respectively, when needed, one of these lift gas supply carts may be wheeled over to the support structure and connected to the lift gas line.

The lift gas supply cart may include a supply of lift gases, such as hydrogen and/or helium, as well as various metering devices which provide for highly accurate metering of the amount of lift gas in the balloon envelope during inflation. The lift gas supply cart may also be configured to provide lift gas to the balloon envelope at very high rates of speed and a range of temperatures, such as between −20 degrees C. to 50 degrees C.

The PLR is also configured to change the position and orientation of the support structure. For instance, returning to FIG. 3, each of the bottom beams 318, 328 may include two or more wheels 390, 392 and 394, 396, respectively. Each wheel may include an independent hydraulics or gear drive system to turn (angle) and rotate (drive) that wheel. The independent movement of each wheel allows the PLR to have many different types of movement such as 2-wheel and 4-wheel drive modes. By changing the orientation of the wheels, the PLR can always be maneuvered such that the fourth open side of the PLR can be rotated to downwind as wind conditions at a launch site change.

The various features of the PLR may be electrically connected to a control system. For instance, user inputs such as a controller, may be included within a cab of the PLR sized to accommodate an operator. These user inputs may allow the operator to communicate with the control system in order to control the movement and position of the wheels 390, 392, 394, 396, platform 502, perch 602, releasable restraint 608, jib cranes 382 and 384, hangar doors, as well as other components of the PLR.

The operator need not rely only on visible observation of the state of the PLR and wind conditions; rather, the PLR may include a data acquisition system. The data acquisition system may include various sensors arranged to detect the position and location of the wheels 390, 392, 394, 396, platform 502, perch 602, releasable restraint 608, the payload positioning assembly, jib cranes 382 and 384, the hangar doors, as well as the load cell(s) arranged to measure tension on the balloon envelope.

The PLR may also include a plurality of sensors configured to detect and provide information regarding current wind conditions outside of the PLR and also within the interior space 302. In addition, the control system may also communicate with the lift gas supply cart 900 or 950 to control the inflating of the balloon envelope, for instance in response to the load cell measurement. These sensors may send information to the control system which processes the information and provides it for display, for example, on an electronic display (not shown) within the cab, to the operator.

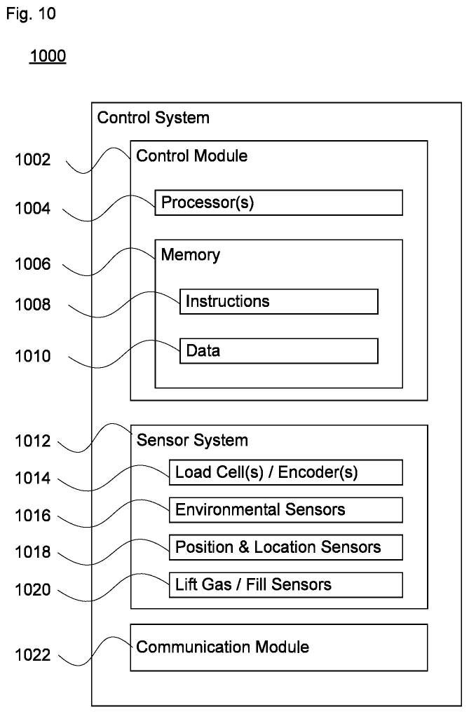

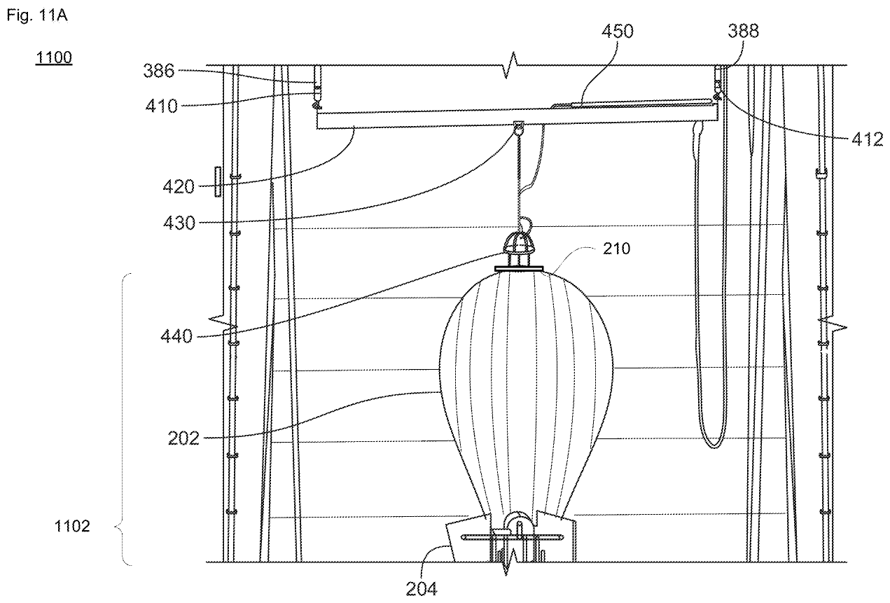

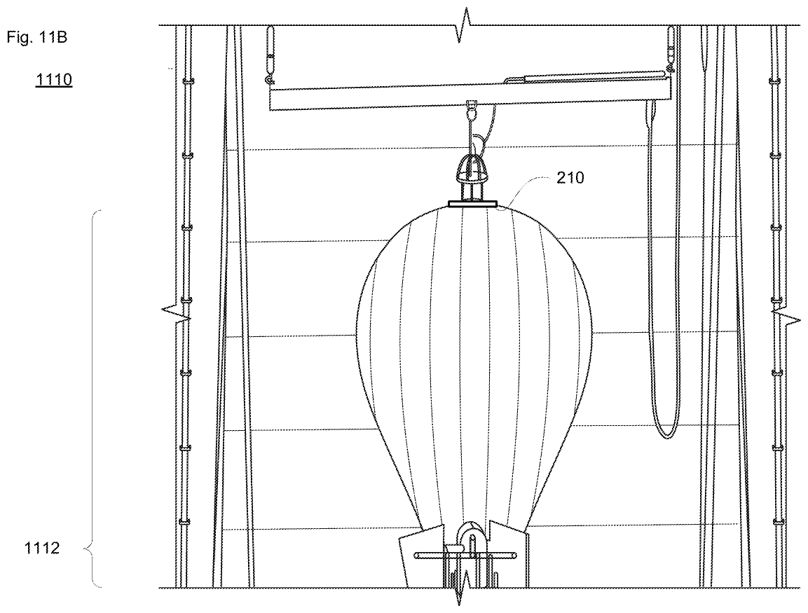

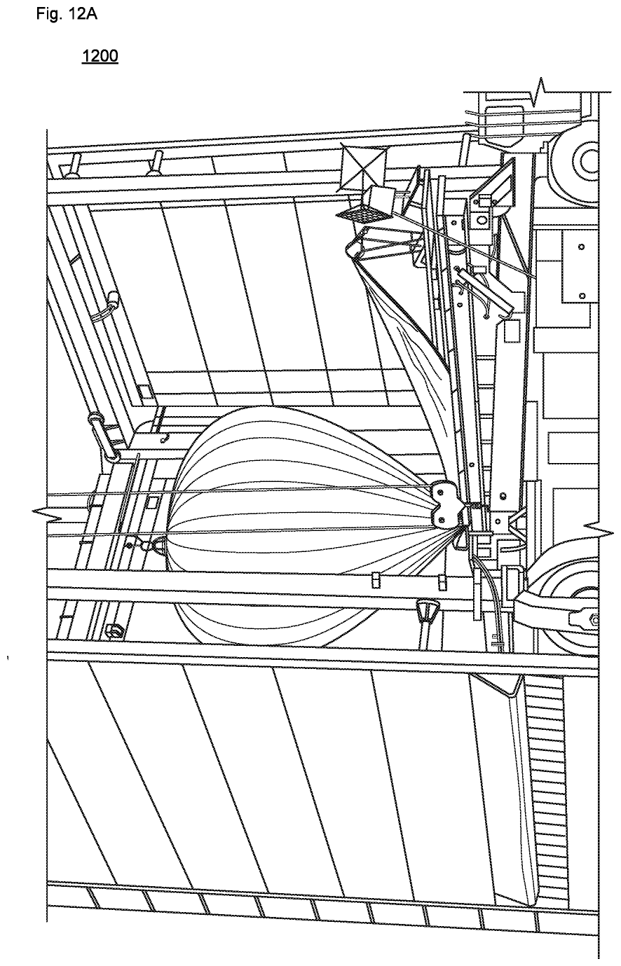

FIG. 10 illustrates an example control system 1000 configured to manage fill and launch, for instance in response to load cell measurements and other data obtained by the various components and sensors of the PLR. In this regard, the control system 1000 may have a control module 1002 including one or more processors 1004, memory 1006, as well as other components typically present in general purpose computing devices. For instance, the memory 1006 stores information accessible by the one or more processors, including instructions 1008 and data 1010 that may be executed or otherwise used by the processor(s) 1004. The memory may be of any type capable of storing information accessible by the processor, including a non-transitory computer-readable medium or other medium that stores data that may be read with the aid of an electronic device, such as a hard-drive, memory card, ROM, RAM, DVD or other optical disks, as well as other write-capable and read-only memories.

The instructions 1008 may be any set of instructions to be executed directly (such as machine code) or indirectly (such as scripts) by the processor. For example, the instructions 1008 may be stored as computing device code on the computer-readable medium. The instructions 1008 may be stored in object code format for direct processing by the processor, or in any other computing device language including scripts or collections of independent source code modules that are interpreted on demand or compiled in advance. The data 1010 may be retrieved, stored or modified by processor(s) 1004 in accordance with the instructions 1008. The one or more processors 1004 may be any conventional processors, such as commercially available CPUs. Alternatively, the one or more processors 1004 may be a dedicated device such as an ASIC or other hardware-based processor. The processor(s), control module, or memory may actually include multiple processors, control modules, or memories that may or may not be stored within the same physical housing.

As shown, the control system 1000 may also include sensor system 1012 that includes one or more load cells or encoder modules 1014 to measure tension on the balloon envelope, environmental sensors 1016 to measure wind, temperature, humidity, etc., position and location sensors 1018 to measure the position and orientation of the PLR, balloon assembly and other components, and lift gas or fill sensors 1020, for instance to measure the flow rate and volume of gas in the envelope.

In addition, the control system 1000 may include a communication module 1022 configured to send information to a remote computer via a communication link so that an operator outside of the cab may still be able to control the movement and position of the wheels, platform, perch, releasable restraint, payload positioning assembly or the features of the cart, jib cranes, the hangar doors, as well as various other features of the PLR. For example, this communication link can be a wired or wireless link that uses several kinds wireless communication protocols, such as WiFi, Bluetooth or other protocols. As with control system 1000, the remote computer may include a processor and memory storing data and instructions as discussed above.

In one scenario, the control system 1000 may operate autonomously. That is, rather than having an operator control the various aspects of balloon fill and/or launch, the control system may use the data from the various sensors to automatically control the movement and position of the wheels, platform, perch, releasable restraint, payload positioning assembly or the features of the cart, jib cranes, the hangar doors, as well as various other features of the PLR according to its instructions. For example, rather than having an operator adjust the position (height) of the platform or the jib cranes as the tension on the balloon envelope increases or decreases, the control system may adjust its position automatically according to the instructions of the control system's memory. Of course, for safety reasons, the control system may be controlled in a manual mode by an operator either within the cab or remotely at any time.

### Example Balloon Positioning, Inflating and Launching

As noted above, the PLR may be used to lift, fill and launch a balloon. In order to do so, at least a portion of the balloon may be positioned within the interior space of the PLR. As shown in FIG. 7, the box 712 containing the balloon envelope 202 may be placed on the perch 602 within the interior space. The payload 204 may be placed on the rest structure 804 (FIG. 8A) and the end portions 706, 708 of arms 702, 704 may be clamped onto the base plate 212. In addition, the roller bar 610 of the releasable restraint 608 may be clamped onto the balloon envelope 202 and slid towards the first end 612 of the perch 602 (FIG. 6) and into the interior space.

In order to lift the balloon envelope 202 out of the box 712, the jib spreader may be positioned over and lowered towards the box. As indicated above, this may be achieved by positioning the first and second arms of the jib cranes and extending the cables 386 and 388. The assembly 440 for lifting the balloon may then be secured to the top plate 210. The hoists of the jib cranes of may then retract the cables 386, 388 in order to raise the jib spreader 420 and pull the balloon envelope out of the box. Prior to or once the assembly 440 is secured to the top plate 210, a lift gas supply cart may be wheeled over to the support structure and connected to the lift gas line 450.

FIG. 11A illustrates a first view 1100 after the assembly 440 is secured to the top plate 210, the lift gas line has been connected. As shown, an initial amount of gas has flowed into the balloon envelope 202 so that it is partially filled. Here, the envelope extends a vertical distance 1102 upward from the box (omitted for clarity). FIG. 11B illustrates a second view 1110 in which the envelope 202 is more fully inflated, as indicated by vertical distance 1112.

In this example, as the envelope is inflated, the jib spreader 420 attached to the top plate 210 is modulated to lower in height (i.e., the distance between the jib spreader and the top plate decreases). Lift gas from the supply cart may flows into the balloon envelope 202 via the lift gas line 450 and assembly 440 until the filling is complete, the desired inflation pressure is reached within the balloon envelope, or an adjustment is to be made to address any tension issues.

Once the fill process has reached the point where the envelope has enough lift gas to bring the balloon and its payload to a desired altitude in the stratosphere, the filling is stopped, the lift gas line 450 is disconnected from the top plate 210 and the balloon is readied for launch. For instance, the releasable restraint may be configured to release the balloon components so that the balloon can move further into the air.

Prior to, during and after the inflation, the features of the PLR may be moved in order to obtain the best possible launch conditions within the interior space as wind conditions around the PLR change. For example, hangar doors may be lowered to reduce the wind within the interior space from the direction of the left side 330, back side 360, and right side 340 of the support structure. Even in situations where the direction of the wind changes, the drive and steering examples above may be used to change the position of the PLR so that the front side 370 is downwind. This can even further reduce the amount of wind within the interior space.

Thus, the platform and/or jib spreader may be raised or lowered in order to raise or lower the position of the top plate (and balloon envelope) and the angle of the perch changed in order to best position the balloon envelope for the current wind conditions at launch, and/or to account for tension as measured by the system.

In one scenario, a load cell is coupled between the jib spreader and the top plate 210. In another scenario, a load cell may be coupled between the releasable restraint 608 and the base load plate 212. In yet another scenario, a first load cell may be disposed between the top plate and the jib spreader, and a second load cell may be disposed between the base load plate and the releasable restraint. In still further scenarios, load cells may be positioned between any other portion of the envelope and the PLR so that envelope tension may be measured during fill.

Regardless of the specific location of the load cell(s), the system may modulate the top and/or bottom (or other) attachment points of the envelope with the PLR based on load cell readings (or the encoder) referenced to the amount of lift gas that has been introduced into the envelope. By way of example, a typical balloon may weigh about 100 lbs at the top load cell before fill. During filling with lift gas, the weight goes down. Once the balloon has enough lift gas to support itself, the system may modulate the attachment points to maintain 20 to 40 lbs as measured by a load cell operatively coupled to the top plate. In contrast, if the load cell is operatively coupled to the base plate or a contact point below the portion of the envelope filling with gas (e.g., at the releasable restraint 608), the load cell readings would be the opposite. In this case, as the envelope fills with gas, there would be an upward force and the system may modulate the attachment points to maintain slightly more than 100 lbs.

The modulation process includes monitoring the load cell readings and adjusting modulation based on the calculated buoyancy of the amount of gas filled. As more lift gas is introduced, the logic executed by the control module allows the PLR to modulate within a range that is determined by the calculated buoyancy. When a threshold is reached that indicates the envelope has enough lift gas to support itself, then it free modulates, i.e., attempts to maintain a desired tension setpoint.

In one aspect, the tension measurement device may include an encoder, in which encoder positioning of the attachment points can also be used in the tension analysis. Here, the encoder would complement the load cell. Encoder positioning can include any system of measuring the location in space of the attachment points. It could be encoders disposed on a motor shaft, or encoders on the cables, or on a positioning sensor on a hydraulic cylinder.

In an alternative configuration, one or both of the releasable restraint or the launch cart may be omitted. In this case, the system would only modulate the top attachment point based on the load cell or encoder readings.

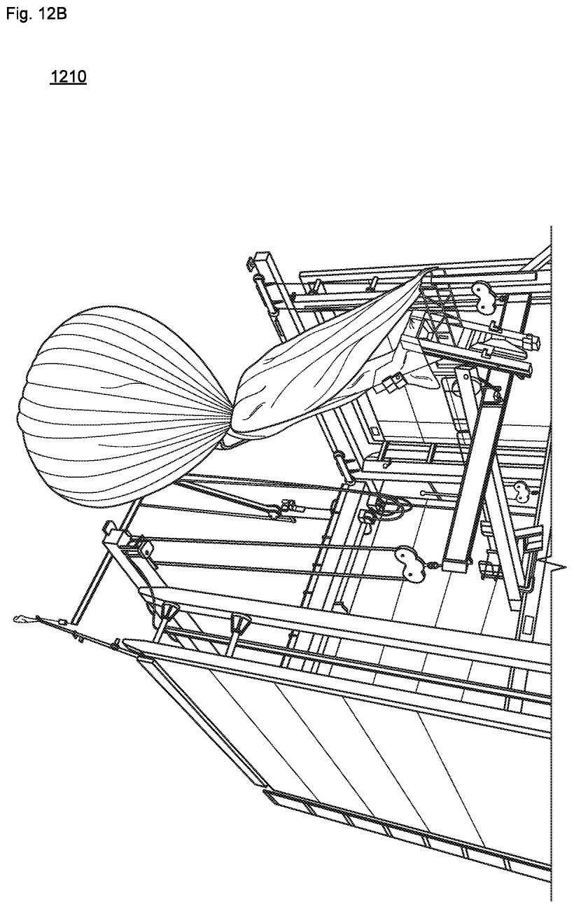

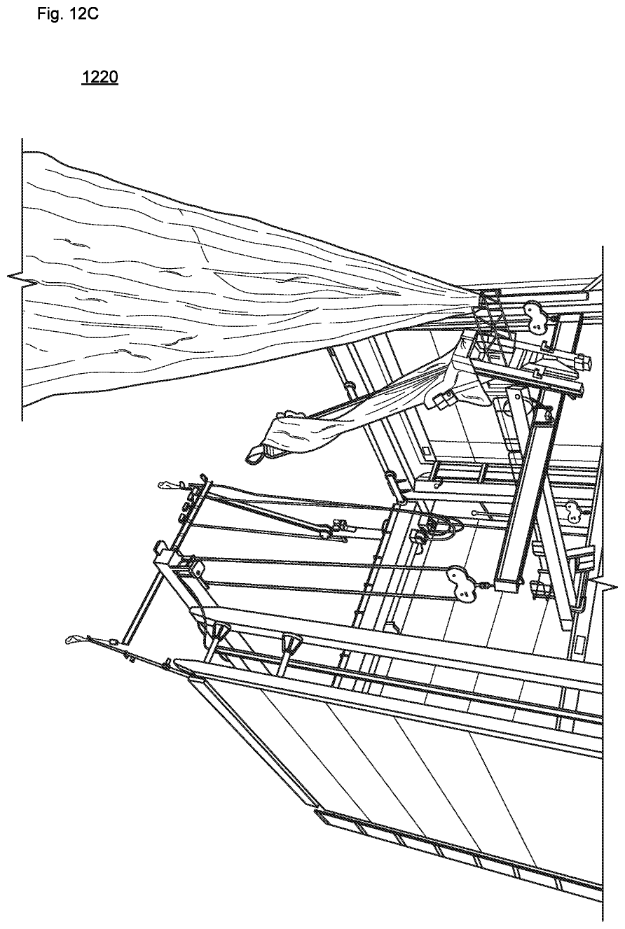

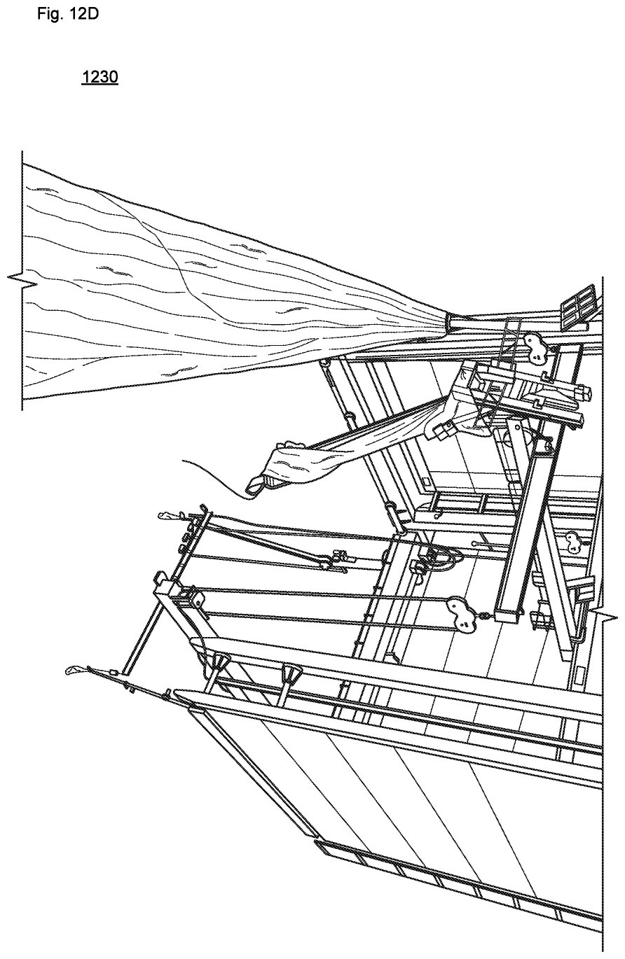

Once the inflating is complete and the PLR (and platform, etc.) are positioned for the current wind conditions where the fourth side 370 is positioned downwind, the balloon 200 may be ready for launch. FIG. 12A illustrates a view 1200 where the filling is complete, or the desired inflation pressure has been reached within the balloon envelope.

At this point, the fill tube from the lift gas line is crimped. Then the top plate 210 may be released from the assembly 440. At the same time or shortly thereafter, the assembly may be pulled away from the top plate 210 (via the jib cranes 382, 384). This may reduce the likelihood of damage to the balloon envelope from hitting the assembly 440 or jib spreader 420 during launch.

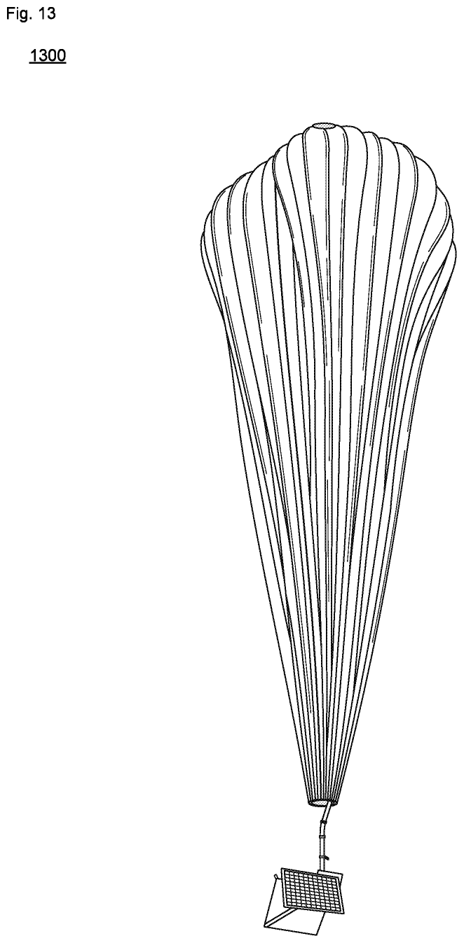

At launch, the first end of the perch is swung upwards as shown in view 1210 of FIG. 12B. Next, the balloon envelope is released from the releasable restraint by swinging the roller bar away from the releasable restraint. This causes the balloon envelope to begin to rise away from the first end of the perch as shown in view 1220 of FIG. 12C. At an appropriate time thereafter, such as when the balloon envelope has passed over (or beyond) the payload, the end portions of the connector arms may be released from the envelope base plate. As shown in view 1230 of FIG. 12D, the arms may swing away from the base plate, thereby allowing the balloon (including the payload) to float away and complete the launch. FIG. 13 illustrates a post-launch view 1300 of the balloon as it ascends to the stratosphere.

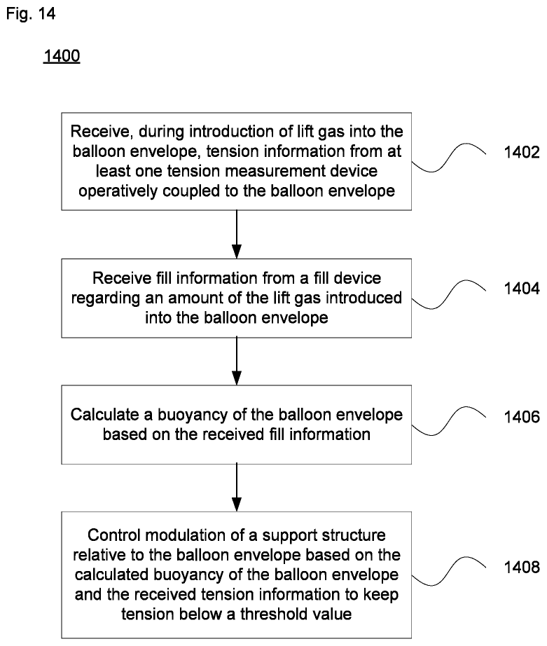

FIG. 14 is a flow diagram 1400 in accordance with some of the aspects described above. As shown in block 1402, during introduction of lift gas into the balloon envelope, tension information is received from at least one tension measurement device operatively coupled to the balloon envelope. At block 1404, fill information is received from a fill device regarding an amount of the lift gas introduced into the balloon envelope. These operations may be performed in a different order or concurrently.

At block 1406, the system calculates a buoyancy of the balloon envelope based on the received fill information. And at block 1408, the system controls modulation of a support structure relative to the balloon envelope based on the calculated buoyancy of the balloon envelope and the received tension information to keep tension below a threshold value.

Aspects, features and advantages of the disclosure will be appreciated when considered with reference to the foregoing description of embodiments and accompanying figures. The same reference numbers in different drawings may identify the same or similar elements. Furthermore, the following description is not limiting; the scope of the present technology is defined by the appended claims and equivalents. While certain processes in accordance with example embodiments are shown in the figures as occurring in a linear fashion, this is not a requirement unless expressly stated herein. Different processes may be performed in a different order or concurrently. Steps may also be added or omitted unless otherwise stated.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments.

1. A system for inflating a balloon including a balloon envelope, the system comprising:
a support structure including two side support members and a lateral support member connecting the two side support members, the support structure defining an interior space for filling the balloon envelope;
a fill device configured to introduce a lift gas into the balloon envelope;
one or more attachment devices releasably coupled to an exterior surface of the balloon envelope along one or more points therealong;
at least one tension measurement device operatively coupled to the one or more attachment devices, the tension measurement device being configured to obtain tension information of the balloon envelope during introduction of the lift gas into the balloon envelope; and
a control module configured to:
receive the tension information from the at least one tension measurement device;
receive fill information from the fill device regarding an amount of the lift gas introduced into the balloon envelope;
calculate a buoyancy of the balloon envelope based on the received fill information; and
control modulation of the support structure relative to the balloon envelope based on the calculated buoyancy of the balloon envelope and the received tension information to keep tension below a threshold value.

2. The system of claim 1, wherein the least one tension measurement device is arranged to obtain tension information associated with a top plate disposed along an apex of the balloon envelope.

3. The system of claim 1, wherein the at least one tension measurement device is arranged to obtain tension information associated with a base plate disposed along a base portion of the balloon envelope.

4. The system of claim 1, wherein the control module is configured to control modulation of the support structure relative to a top plate disposed along an apex of the balloon envelope.

5. The system of claim 1, wherein the control module is configured to control modulation of the support structure relative to a releasable restraint coupled to a portion of the balloon envelope.

6. The system of claim 1, wherein the control module is configured to vary modulation of the support structure relative to the balloon envelope depending upon a location of the least one tension measurement device.

7. The system of claim 1, wherein the control module is further configured to control modulation of the support structure relative to the balloon envelope based on information received from one or more of an environmental sensor, a position sensor, or a location sensor.

8. The system of claim 1, wherein the control module controls modulation of the support structure by adjusting a height of a moveable beam.

9. The system of claim 1, further comprising a platform or moveable perch, the platform or moveable perch being arranged to support the balloon during fill.

10. The system of claim 1, wherein when a threshold is reached indicating that the balloon envelope has enough lift gas to support itself, then the control module enables the balloon envelope to free modulate itself.

11. The system of claim 1, wherein the at least one tension measurement device is a load cell.

12. The system of claim 12, wherein the at least one tension measurement device further includes an encoder.

13. The system of claim 1, further comprising the balloon.

14. A method of filling a balloon for launch, the balloon including a balloon envelope and payload, the method comprising:
receiving during introduction of lift gas into the balloon envelope, by one or more processors of a control module, tension information from at least one tension measurement device operatively coupled to the balloon envelope;
receiving, by the one or more processors, fill information from a fill device regarding an amount of the lift gas introduced into the balloon envelope;
calculating, by the one or more processors, a buoyancy of the balloon envelope based on the received fill information; and
the one or more processors controlling modulation of a support structure relative to the balloon envelope based on the calculated buoyancy of the balloon envelope and the received tension information to keep tension below a threshold value.

15. The method of claim 14, wherein controlling the modulation of the support structure includes modulating the support structure relative to a top plate of the balloon disposed along an apex of the balloon envelope.

16. The method of claim 14, wherein controlling the modulation of the support structure includes modulating the support structure relative to a releasable restraint coupled to a portion of the balloon envelope.

17. The method of claim 14, wherein controlling the modulation of the support structure includes varying modulation of the support structure relative to the balloon envelope depending upon a location of the least one tension measurement device.

18. The method of claim 14, wherein controlling the modulation of the support structure is further based on information received from one or more of an environmental sensor, a position sensor, or a location sensor.

19. The method of claim 14, wherein controlling the modulation of the support structure includes adjusting a height of a moveable beam of the support structure.

20. A non-transitory computer-readable recording medium having instructions stored thereon, the instructions, when executed by one or more processors of a control module, cause the control module to implement a method of filling a balloon for launch, the balloon including a balloon envelope and payload, the method comprising:
receiving, during introduction of lift gas into the balloon envelope, tension information from at least one tension measurement device operatively coupled to the balloon envelope;
receiving fill information from a fill device regarding an amount of the lift gas introduced into the balloon envelope;
calculating a buoyancy of the balloon envelope based on the received fill information; and
controlling modulation of a support structure relative to the balloon envelope based on the calculated buoyancy of the balloon envelope and the received tension information to keep tension below a threshold value.
